(19) United States
(12) Patent Application Publication
(10) Pub. No.: US 2005/0209915 A1
(43) Pub. Date: Sep. 22, 2005

(54) System for processing a prescription bottle containing a customized promotional message or greeting card message and method thereof

(76) Inventor: Raymond Saluccio, Colonia, NJ (US)

Correspondence Address: EZRA SUTTON, P.A., PLAZA 9, 900 RT. 9, WOODBRIDGE, NJ, 07095, US

(21) Appl. No.: 10/801,227

(22) Filed: Mar. 16, 2004

(51) Int. Cl. G06F 17/60; B42D 15/00

(52) U.S. Cl. 705/14; 705/26

(57) ABSTRACT

The electronic system is used on the Internet for selecting and ordering realistic looking prescription containers and prescription labels having emotional expressions or promotional messages selected by one of a plurality of customers wherein each customer communicates from a remote site to a distribution center on the Internet. The system includes a customer access terminal at each remote site having an input device for customer input data and prescription label data; a memory device for storage of data in the form of data records, including the customer input data and the prescription label data; and a display monitor for displaying textual information representative of the prescription label data. The customer access terminal at each remote site also has a processor coupled to the display monitor, the memory device, and the input device for processing and controlling display of the prescription label data to facilitate generating a prescription labeled container. The customer access terminal also provides for generating and storing in the memory device the records of the prescription labeled container, order history data, and order status data which are operatively linked to facilitate management of the delivery of the prescription labeled container to the customer.

### FIELD OF THE INVENTION

The present invention relates to an improved computerized online system for processing, selecting and ordering prescription labeled containers wherein the prescription label features promotional expressions or social expressions.

### BACKGROUND OF THE INVENTION

Presently there exists various methods for purchasing novelty greeting items, products or cards from various venues that include automated kiosks, retail gift shops, catalogs, magazines, newspapers or by means of the Internet, etc. In addition, the various greeting items offered by the aforementioned venues of purchasing are often limited to products such as greeting cards, balloons, flowers, picture frames and the like. These items often lack originality and feature typical greetings which do not permit the buyer to create their own unique or personalized emotional greeting message or promotional message for promoting a product.

Thus, there is a need for ordering and selling prescription containers/bottles on the Internet which feature a realistic looking prescription bottle and label but with a social expression written on the label in the form of a Pharmacist's medication directions chosen or created by the consumer or buyer and filled with candy or other filler of the buyer's choice. Additionally, this social expression or greeting on the prescription bottle label can be a customized emotional message for expressing an emotion, such as “Take three (3) hugs every four (4) hours”. Alternatively, there can be a promotional message on the label for promoting the sale of a product such as a teddy bear.

### DESCRIPTION OF THE PRIOR ART

Personalizing of greeting cards and various systems for producing such greeting cards have been disclosed in the prior art. For example, U.S. Pat. No. 5,056,029 to CANNON discloses a method and apparatus for manufacturing and vending social expression cards. The apparatus is used for point of sale card manufacturing and vending having information storage and a retrieval system for storing, referencing, and retrieving various social expressions and card designs from a database.

U.S. Pat. No. 5,555,496 to TACKBARY et al. discloses a method and apparatus for communicating with a card distribution center for management, selection, and delivery of social expression cards. A system is used for communicating with a card distribution center for selecting, ordering, and sending social expression cards using a personal computer.

U.S. Pat. No. 6,535,294 to ALEDGE, JR. et al. discloses a system and method for preparing customized printed products over a communication network. The system provides for a web server computer connected to the network; and a printed product preparation system for allowing an end-user anonymously connected to the web server computer through at least one retailer web server to prepare an electronic file defining a customized printed product.

None of the aforementioned prior art patents teach or disclose the method for ordering and designing prescription labeled containers, bottles or vials such that the prescription label displays a customized social expression or promotional expression.

Accordingly, it is an object of the present invention to provide a system for selecting and ordering prescription labeled containers, bottles and vials such that the prescription labels display a customized social expression or promotional expression.

Another object of the present invention is to provide a prescription labeled container or bottle having a customized promotional message thereon, wherein the promotional message is used for promoting the sale of a consumer product, such as a teddy bear, jewelry, an accessory, a watch, a vacation, a souvenir and the like.

Another object of the present invention is to provide a prescription labeled container or bottle having a customized emotional message thereon, wherein in the emotional message is used for expressing a personal emotion, such as happiness, joy, love, sarcasm and the like, such as “Take three (3) hugs every four (4) hours”.

Another object of the present invention is to provide a prescription labeled container or bottle having a filler therein, wherein the filler is in the form of candy, cookies, chocolates, mints and the like.

Another object of the present invention is to provide a system that is compatible with the Internet, easy to use and access, and is readily affordable by the consumer.

### SUMMARY OF THE INVENTION

In accordance with the present invention, there is provided a system being employed on the Internet for ordering and designing a promotional product in the form of a prescription bottle containing a promotional message. The system includes preparing a customized promotional message on the Internet for promoting a product, such as a teddy bear. The customized promotional message in the form of a prescription label is attached to a prescription bottle. A filler, such as candy, is selected to be inserted into the prescription bottle. The customer then orders the prescription bottle, the promotional message, and the filler all to be delivered to the customer.

In an alternate embodiment, the system of the present invention is employed on the Internet for ordering and designing an emotional product in the form of a prescription bottle containing an emotional message. The system includes preparing a customized emotional message on the Internet for expressing a personal emotion. The customized emotional message in the form of a prescription label is attached to a prescription bottle. A filler, such as candy is selected to be inserted into the prescription bottle. The customer then orders the prescription bottle, the customized emotional message, and the filler, all to be delivered to the customer.

Additionally, the electronic system of the present invention is used on the Internet for selecting and ordering labeled prescription containers wherein the prescription labels have emotional expressions or promotional messages selected by one of a plurality of independent customers wherein each customer communicates from a remote site to a distribution center on the Internet. The system includes a customer access terminal at each remote site having an input device for customer input data and prescription label data; a memory device for storage of data in the form of data records, including the customer input data and the prescription label data; and display means for displaying textual information representative of the prescription label data. The customer access terminal at each remote site also has a processor coupled to the display means, the memory device, and the input device for processing and controlling display of the prescription label data to facilitate generating a prescription labeled container. The customer access terminal also provides for generating and storing in the memory device the records of the prescription labeled container, order history data, order status data which are operatively linked to facilitate management of the delivery of the prescription labeled container to the customer.

The promotional product of the present invention is in the form of a prescription bottle and label and contains a promotional message. The promotional product includes a customized promotional message for promoting a product, such as a teddy bear. The promotional product also includes means for attaching said promotional message in the form of a prescription label onto a prescription bottle. The promotional product further includes a filler, such as candy, contained within the prescription bottle; and means for displaying and ordering the prescription bottle, the label with the promotional message, and the filler.

The emotional product of the present invention is in the form of a prescription bottle and label and contains an emotional message. The emotional product includes a customized emotional message for expressing a personal emotion. The emotional product also includes means for attaching the emotional message in the form of a prescription label onto a prescription bottle. The emotional product further includes a filler, such as candy, contained within the prescription bottle; and means for displaying and ordering the prescription bottle, the label with the emotional message, and the filler.

### BRIEF DESCRIPTIONS OF THE DRAWINGS

Further objects, features and advantages of the present invention will become apparent upon the consideration of the following detailed description of the presently preferred embodiment when taken in conjunction with the accompanying drawings, wherein:

FIG. 1A is a front perspective view of the promotional product of the first embodiment of the present invention showing a realistic looking prescription bottle having a prescription label with a customized promotional message thereon;

FIG. 1B is a front perspective view of the promotional product of the first embodiment of the present invention showing a prescription container having a prescription label with a customized promotional message thereon;

FIG. 2A is a front perspective view of the emotional product of the second embodiment of the present invention showing a prescription bottle having a prescription label with a customized emotional message thereon;

FIG. 2B is a front perspective view of the emotional product of the second embodiment of the present invention showing a prescription container having a prescription label with a customized emotional message thereon;

FIG. 3 is a generalized block diagram of the system of the first embodiment of the present invention illustrating the steps of preparing, attaching, selecting and ordering of a labeled prescription bottle having a customized promotional message thereon;

FIG. 4 is a generalized block diagram of the system of the second embodiment of the present invention illustrating the steps of preparing, attaching, selecting and ordering of a labeled prescription container having a customized emotional message thereon;

FIG. 5 is a generalized block diagram of the system of the present invention illustrating the steps of communicating, inputting data, memorizing of data, displaying of data, processing of data and storing of data for the production of the prescription labeled container for the customer; and

FIG. 6 is a generalized flow chart of the system of the present invention illustrating the hardware and the connectors between the hardware and the distribution center on the Internet Web.

### DETAILED DESCRIPTION OF THE EMBODIMENTS

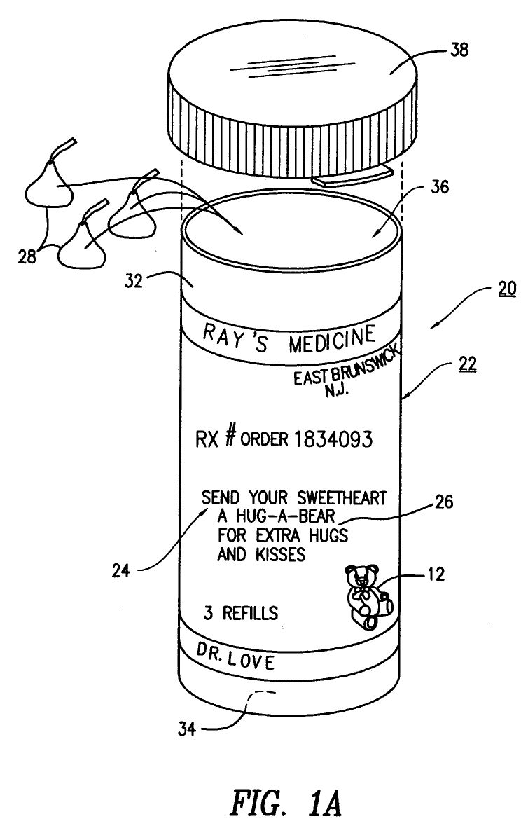

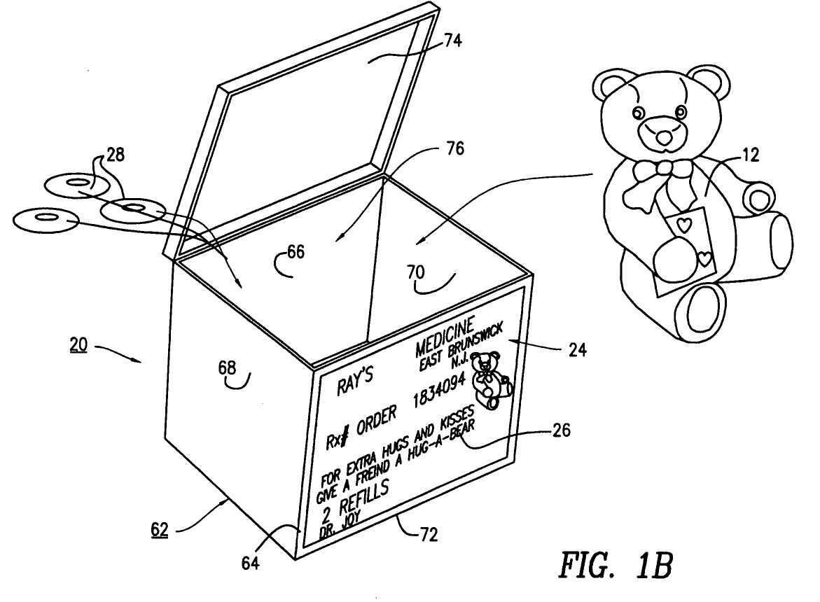

The electronic system 10 and the hardware and software of the preferred embodiment of the present invention is represented in detail by FIGS. 1A, 1B, 2A, 2B and 3 to 6 of the patent drawings. The electronic system 10 of the present invention is used on the Internet for selecting and ordering labeled prescription bottles 22 or 122 and containers 62 or 162 for use with a promotional product 20 or an emotional product 120, respectively.

As shown in FIGS. 1A, 1B, 3 and 5, the promotional product 20 of the first embodiment of the present invention is in the form of a prescription bottle 22 or prescription container 62 having a prescription label 24 thereon that contains a customized promotional message 26 for promoting the sale of a consumer product 12, such as a teddy bear, jewelry, an accessory, a watch and the like. For example, the customized promotional message 26 on label 24 reads “Send Your Sweetheart a Hug-A-Bear for Extra Hugs and Kisses” which promotes the selling of teddy bears 12 to the buyer, as shown in FIG. 1A. The promotional product 20 also includes means for attaching the prescription label 24 having the customized promotional message 26 on the prescription bottle 22 or prescription container 62.

The promotional product 20 further includes a filler 28, such as candy, cookies, chocolates, mints, other sweets and the like contained within the prescription bottle 22; and means for displaying and ordering the prescription bottle 22 or container 62, the customized promotional message 26, and the filler 28. The container 62 for receiving filler 28, such as candy, may also be a package having a prescription label 24 on the package for packaging a chocolate bar, a gift or a product therein.

The prescription bottle 22 includes an outer circumferential wall surface 32 and a bottom wall 34 for forming an interior space 36 for receiving the consumer product 12 and/or the filler 28 therein. The prescription bottle 22 also includes a removable cap 38 thereon. The wall surface 32 of prescription bottle 22 is used for adhering the prescription label 24 thereon, as shown in FIG. 1A. Alternatively, the prescription container 62 includes a front wall 64, a rear wall 66, side walls 68 and 70, a bottom wall 72 and a flip cover 74 for forming an interior space 76 for receiving the container product 12 and/or filler 28 therein. The front wall 64 is used for adhering the prescription label 24 thereon containing the customized promotional message 26, as shown in FIG. 1B of the drawings.

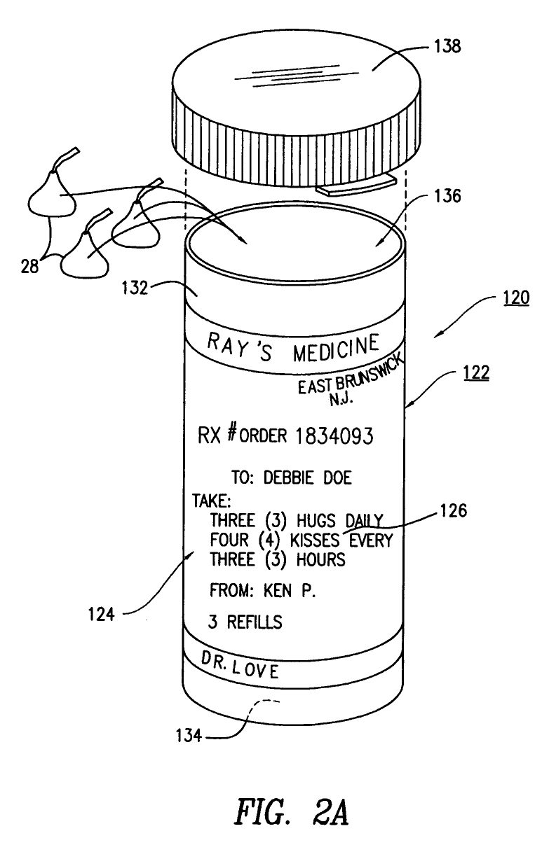

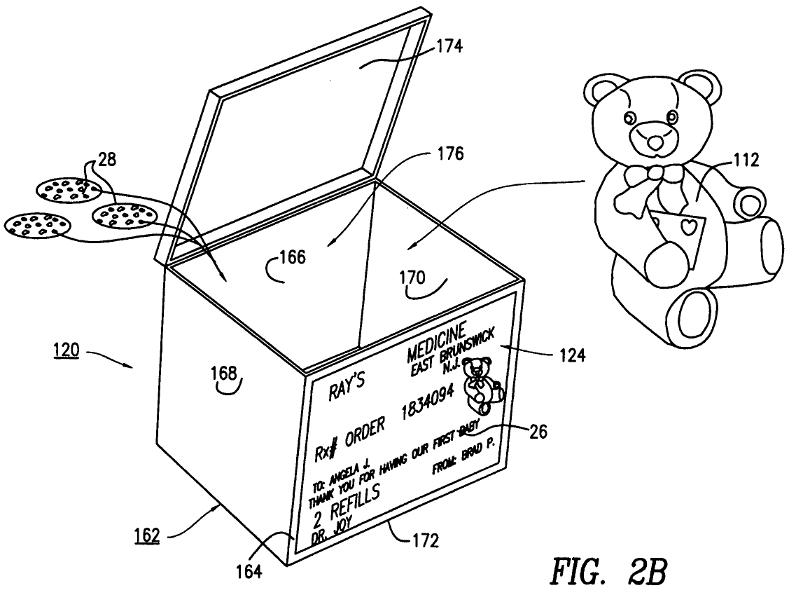

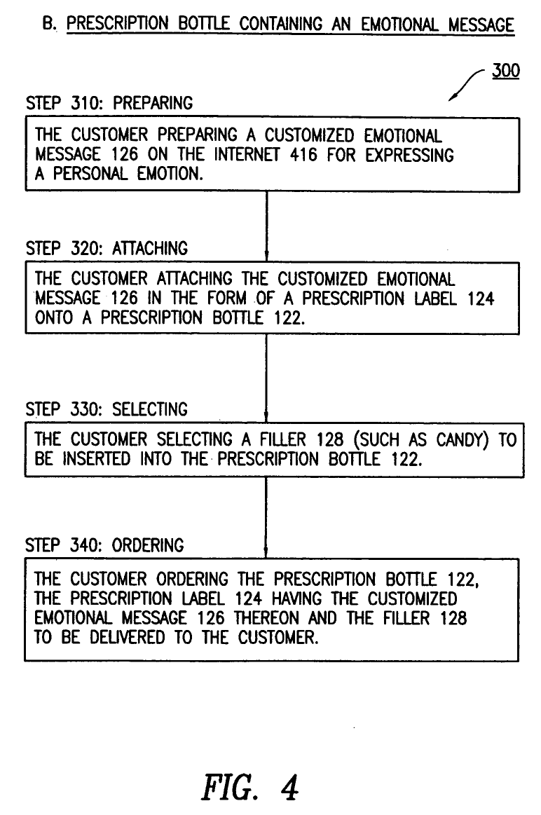

As shown in FIGS. 2A, 2B and 4, the emotional product 120 of the second embodiment of the present invention is in the form of a prescription bottle 122 or prescription container 162 having a prescription label 124 thereon that contains a customized emotional message 126 for expressing a personal emotion, such as happiness, love, joy, sadness, sarcasm, silliness and the like. For example, the emotional message 126 on label 124 reads “Take three (3) Hugs Daily, Four (4) Kisses Every Three (3) Hours” which sends the emotion of love to the user, as shown in FIG. 2A. The emotional product 120 also includes means for attaching the prescription label 124 containing the customized emotional message 126 onto the prescription bottle 122 or prescription container 162.

The emotional product 120 further includes a filler 128, such as candy, cookies, chocolates, mints, other sweets and the like contained within the prescription bottle 122 or container 162; and means for displaying and ordering the prescription bottle 122 or container 162, the customized emotional message 126, and the filler 128. The container 162 for receiving filler 128, such as candy, may also be a package having a prescription label 124 on the package for packaging a chocolate bar, a gift or a product therein.

The prescription bottle 122 includes an outer circumferential wall surface 132 and a bottom wall 134 for forming an interior space 136 for receiving the consumer product 112 and/or the filler 128 therein. The prescription bottle 122 also includes a removable cap 138 thereon. The wall surface 132 of prescription bottle 122 is used for adhering the prescription label 124 thereon, as shown in FIG. 2A. Alternatively, the prescription container 162 includes a front wall 164, a rear wall 166, side walls 168 and 170, a bottom wall 172 and a flip cover 174 for forming an interior space 176 for receiving the container product 112 and/or filler 128 therein. The front wall 164 is used for adhering the prescription label 124 thereon containing the customized emotional message 126, as shown in FIG. 2B of the drawings.

### OPERATION OF THE PRESENT INVENTION

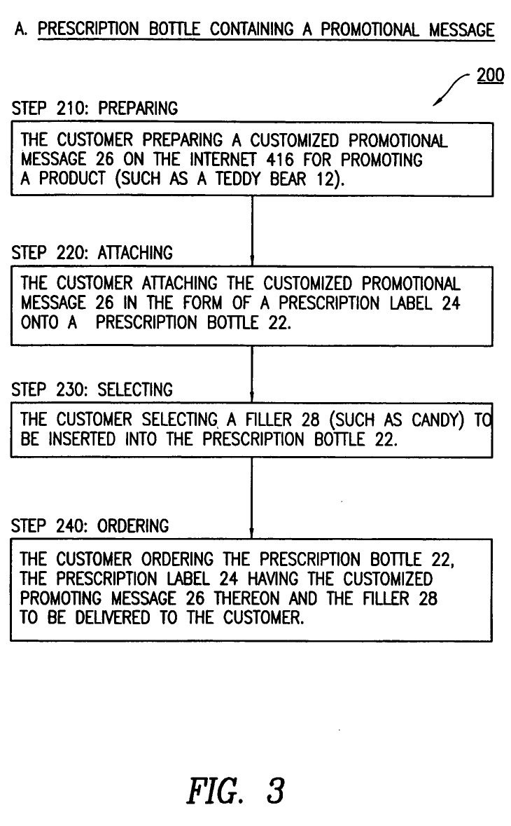

The method 200 for processing a prescription bottle 22 or prescription container 62 containing a customized promotional message 26 for a promotional product 20, is shown in FIG. 3 of the drawings, and includes the following steps of preparing 210; attaching 220; selecting 230 and ordering 240.

To start the processing method 200, the buyer prepares (step 210) a customized promotional message 26 on the Internet system 400 for promoting the sale of a promotional product 20 such as a teddy bear 12. The buyer now attaches (step 220) the customized promotional message 26 in the form of a prescription label 24 onto a prescription bottle 22 or container 62 via the distribution center 404. The buyer now proceeds in selecting (step 230) a filler 28, such as candy, to be inserted into the interior space 36 or 76 of the prescription bottle 22 or container 62, accordingly, at the distribution center 414. In the last step, the buyer proceeds to ordering (step 240) using the Internet system 400 for ordering the prescription bottle 22 or prescription container 62, the prescription label 24 having the customized promotional message 26 thereon, and the filler 28 all to be delivered to the buyer at a remote site 412.

The method 300 for processing a prescription bottle 122 or prescription container 162 containing a customized emotional message 126 for an emotional product 120, is shown in FIG. 4 of the drawings, and includes the following steps of preparing 310; attaching 320; selecting 330 and ordering 340.

To start the processing method 300, the buyer prepares (step 310) a customized emotional message 126 on the Internet system 400 for providing an emotional product 120 for expressing a personal emotion, such as love,joy and/or happiness. The buyer now attaches (step 320) the customized emotional message 126 in the form of a prescription label 124 onto a prescription bottle 122 or prescription container 162 via the distribution center 414. The buyer now proceeds in selecting (step 330) a filler 128, such as candy, to be inserted into the interior space 136 or 176 of the prescription bottle 122 or prescription container 162, accordingly, at the distribution center 414. In the last step, the buyer proceeds to ordering (step 340) using the Internet system 400 for ordering the prescription bottle 122 or prescription container 162, the prescription label 124 having the customized emotional message 126 thereon, and the filler 128 all to be delivered to the buyer at a remote site 412.

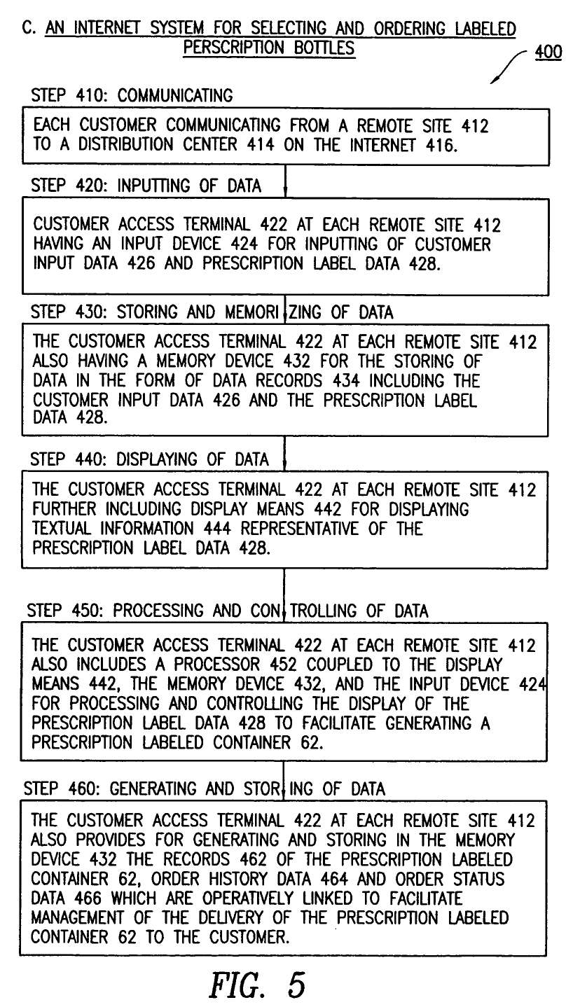

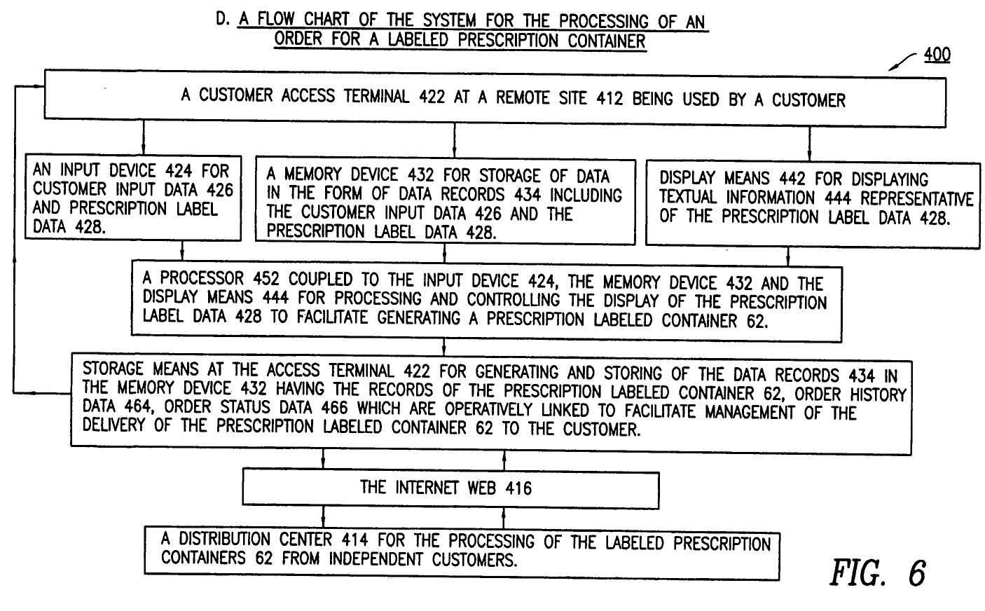

The method 400 of an Internet System for selecting and ordering of labeled prescription bottles 22 or 122 or prescription containers 62 or 162, is shown in FIGS. 5 and 6 of the drawings, and includes the following steps of communicating 410; inputting of data 420; storing and memorizing of data 430; displaying of data 440; processing and controlling of data 450; and generating and storing of data 460.

To start the aforementioned method of the Internet system 400, each customer is communicating (step 410) from a remote site 412 to a distribution center 414 on the Internet 416. The customer then proceeds to a customer access terminal 422 at each remote site 412 having an input device 424 for inputting of data (step 420), such as customer input data 426 and prescription label data 428. Also, the customer access terminal 422 at each remote site 412 (proceeding concurrently) includes a memory device 432 for storing and memorizing of data records (step 430), such as the customer input data 426 and the prescription label data 428 which forms the data records 434.

Further, at the customer access terminal 422 at each remote site 412 (proceeding concurrently) also includes a display monitor 442 for displaying (step 440) the textual information 444 representative of the prescription label data 428. Additionally, the customer access terminal 422 at each remote site 412 (proceeding concurrently) includes a processor device 452 coupled to the input device 424, the memory device 432 and the display monitor 442 for the processing and controlling of data (step 450), such as the display text/font information 444 of the prescription label data 428 in order to facilitate the generating of a prescription labeled bottle 22, 122 or container 62, 162, respectively. In the last step, the customer access terminal 422 at each remote site 412 also provides for generating and storing (step 460) in the memory device 432 the records 462 of the prescription labeled bottle 22, 122 or container 62, 162, order history data 464, and order status data 466 which are operatively linked to facilitate management of the prescription labeled bottle 22, 122 or container 62, 162 to the customer, as shown in the flow chart C of FIG. 5 of the drawings.

### ADVANTAGES OF THE PRESENT INVENTION

Accordingly, an advantage of the present invention is that it provides for an electronic Internet system for the management, selection and ordering of prescription labeled containers, bottles and vials such that the prescription labels display a customized social expression wherein each customer communicates from a remote site to a distribution center.

Another advantage of the present invention is that it provides for a prescription labeled container or bottle having a label with a customized promotional message thereon, wherein the promotional message is used for promoting the sale of a consumer product, such as a teddy bear, jewelry, an accessory, a watch, a vacation and the like.

Another advantage of the present invention is that it provides for a prescription labeled container or bottle having a label with a customized emotional message thereon, wherein the emotional message is used for expressing a personal emotion, such as happiness, joy, sarcasm and the like.

Another advantage of the present invention is that it provides for a prescription labeled container or bottle having a filler therein, wherein the filler is in the form of candy, cookies, chocolates, mints, other sweets and the like.

Another advantage of the present invention is that it provides for a system that is compatible with the Internet, easy to use and access, and is readily affordable by the consumer.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

1. A system on the Internet for ordering and designing a promotional product in the form of a prescription bottle or container containing a promotional message, comprising the steps of:
(a) preparing a prescription label containing thereon a customized promotional message for promoting a product;
(b) attaching said prescription label onto a prescription bottle or container;
(c) selecting a filler to be inserted into said prescription bottle or container; and
(d) ordering said prescription bottle or container, said promotional message, and said filler to be delivered to the user.

2. A method of an Internet system in accordance with claim 1, wherein said step of preparing said customized promotional message on the Internet for promoting said product, said product is selected from the group consisting of a teddy bear, jewelry, an accessory, a watch and a souvenir.

3. A method of an Internet system in accordance with claim 1, wherein said step of selecting said filler to be inserted into said prescription bottle, said filler is selected from the group consisting of candy, cookies, chocolates, mints and other sweets.

4. A system on the Internet for ordering and designing an emotional product in the form of a prescription bottle or container containing an emotional message, comprising the steps of:
(a) preparing a prescription label containing thereon a customized emotional message for expressing an emotion;
(b) attaching said prescription label onto a prescription bottle or container;
(c) selecting a filler to be inserted into said prescription bottle or container; and
(d) ordering said prescription bottle or container, said emotional message, and said filler to be delivered to the user.

5. A method of an Internet system in accordance with claim 4, wherein said step of preparing said customized emotional message for expressing said emotion, said message is selected from a group of messages consisting of happiness, love, joy, silliness, sarcasm and combinations thereof.

6. A method of an Internet system in accordance with claim 4, wherein said step of selecting said filler to be inserted into said prescription bottle, said filler is selected from the group consisting of candy, cookies, chocolates, mints and other sweets.

7. An electronic system on the Internet for selecting and ordering labeled prescription containers wherein the prescription labels have emotional expressions or promotional messages selected by one of a plurality of independent customers wherein each customer communicates from a remote site to a distribution center on the Internet, the system comprising:
(a) a customer access terminal at each remote site having:
(1) an input device for customer input data and prescription label data;
(2) a memory device for storage of data in the form of data records, including said customer input data and said prescription label data;
(3) display means for displaying textual information representative of the prescription label data;
(4) a processor coupled to said display means, said memory device, and said input device for processing and controlling the display of the prescription label data to facilitate generating a prescription labeled container, and for generating and storing in said memory device the records of said prescription labeled container, order history data, and order status data which are operatively linked to facilitate management of the delivery of said prescription labeled container to the customer.

8. A promotional product in the form of a prescription bottle or container containing a promotional message, comprising:
(a) a prescription label containing thereon a customized promotional message for promoting a product;
(b) means for attaching said prescription label onto a prescription bottle or container;
(c) a filler contained within said prescription bottle or container; and
(d) means for displaying and ordering said prescription bottle or container, said promotional message, and said filler.

9. A promotional product in accordance with claim 8, wherein said product is selected from the group consisting of a teddy bear, jewelry, an accessory, a watch, or a souvenir.

10. A promotional product in accordance with claim 8, wherein said filler is selected form the group consisting of candy, cookies, chocolates, mints or other sweets.

11. An emotional product in the form of a prescription bottle or container containing an emotional message, comprising:
(a) a prescription label containing thereon a customized emotional message for expressing an emotion;
(b) means for attaching said prescription label onto a prescription bottle or container;
(c) a filler contained within said prescription bottle or container; and
(d) means for displaying and ordering said prescription bottle or container, said emotional message, and said filler.

12. An emotional product in accordance with claim 11, wherein said message is selected from a group of messages consisting of happiness, love,joy, sarcasm or combinations thereof.

13. An emotional product in accordance with claim 11, wherein said filler is selected from the group consisting of candy, cookies, chocolates, mints or other sweets.

14. A promotional product in the form of a prescription package containing a promotional message, comprising:
(a) a prescription label containing thereon a customized promotional message for promoting a product;
(b) means for attaching said prescription label onto a prescription package;
(c) a product contained within said prescription package; and
(d) means for displaying and ordering said prescription package, said promotional message, and said product.

15. An emotional product in the form of a prescription package containing an emotional message, comprising:
(a) a prescription label containing thereon a customized emotional message for expressing an emotion;
(b) means for attaching said prescription label onto a prescription package;
(c) a product contained within said prescription package; and
(d) means for displaying and ordering said prescription package, said emotional message, and said product.
